(19) United States
(12) Patent Application Publication
(10) Pub. No.: US 2024/0262400 A1
(43) Pub. Date: Aug. 8, 2024

(54) System and Method for Obtaining, Transmitting and Maintaining Automated Single-Car Test Device Railway Brake Test Results

(71) Applicant: Buckeye Mountain, Inc., Akron, OH (US)

(72) Inventors: Justin PRATT, Akron, OH (US); Matthew HUNTER, Akron, OH (US)

(21) Appl. No.: 18/107,335

(22) Filed: Feb. 8, 2023

(51) Int. Cl. B61L 27/60

(52) U.S. Cl. CPC B61L 27/60; B61L 2205/00

(57) ABSTRACT

A communications device connected between an automated single car test device and a cloud-based secure repository automatically reads air brake test results from the automated single car test device via a multipin connector designed to connect to a touch screen tablet and provides external interned based access to an automated single car test device.

### CROSS-REFERENCE TO RELATED APPLICATIONS

None

### FIELD

The technology herein relates to rolling stock testing, and more particularly to systems and methods for testing railcar air brakes. Still more particularly, the technology herein relates to systems and methods for testing air brakes of a single railcar, and to automated transfer controllers for interfacing with automated rail car brake testing devices.

### BACKGROUND

Anyone who has watched a freight train pass by has marveled at the huge variety of train cars of many different configurations, colors, shapes and markings. There are literally millions of freight cars in North America. Some cars may be owned by the railroad operating the cars, but other cars may travel from railroad to railroad. Some cars may be owned by the railroad, others may be leased. whereas other cars are privately owned.

All those cars of a moving train have a huge amount of momentum that needs to be removed for the train to stop. The train's brakes apply friction by bringing brake blocks or pads made from cast iron and composite materials to the train's rotating wheels or to discs attached to the axles. The brake blocks or pads create friction and convert the kinetic energy into heat. The wheels slow down and eventually the train stops. See http://www.railway-technical.com/trains/rolling-stock-index-1/train-equipment/brakes/

### Train Braking Systems

The vast majority of the world's trains are equipped with braking systems that use compressed air as the force to push the brake blocks or pads onto the wheels or discs. These systems are known as “air brakes” or “pneumatic brakes”. See FIG. 1. The compressed air is transmitted along the train through a “brake pipe” or, in North America, a “train line” connecting to (and through) all of the cars of the train. Changing the level of air pressure in the pipe causes a change in the state of the brake on each wheel of each rail car of the train. It can apply the brake, release it or hold it “on” after a partial application. Typically, the default of such a system is to apply the brakes when there is no or low air pressure and to release the brakes when air pressure exceeds a certain level. This system is in widespread use throughout the world. Id.

FIG. 2 shows a schematic diagram of an air brake system on a typical railcar. The air is drawn into a compressor on the locomotive, compressed and stored under pressure in a main reservoir at 7-10 bar (100-140 lbs/sq.in). See e.g., https://www.wabteccorp.com/locomotive/air-generation-and-treatment/compressors. Compressed air from the main reservoir on the locomotive is distributed along the train through the main reservoir brake pipe. On each railcar, the brake pipe is connected through a triple valve or distributor to an auxiliary reservoir disposed on the car which stores air for use on that car's brake system. Each railcar has its own auxiliary reservoir that must be charged to store compressed air. The brake pipe thus does two jobs—it delivers compressed air to each car for the car to store in its auxiliary reservoir, and it uses different pressure levels to signal or control the brakes on each wheel of each car of the train—which may be hundreds of cars long in some cases—based on a brake valve on the train engineer's control console. The engineer operates the brake value (or in some cases an emergency brake value) in the locomotive to control the triple valves or distributors of all the cars of the train. Increasing the pressure in the brake pipe causes the cars' brakes to release, while decreasing the pressure causes the cars' brakes to apply.

The operation of the brakes on each vehicle or railcar is typically controlled by the triple valve or distributor that functions to release the brake, apply it and hold it at the current level of application, based on the current pressure in the brake pipe from the locomotive. The triple valve of each car typically contains a slide valve which detects changes in the brake pipe pressure and rearranges the connections inside the valve accordingly. It either recharges the railcar's auxiliary reservoir and opens the brake cylinder exhaust, closes the brake cylinder exhaust and allows the auxiliary reservoir air to feed into the brake cylinder, or holds the air pressures in the auxiliary reservoir and brake cylinder at the current level.

FIG. 3A diagram shows the condition of a car's brake cylinder, triple valve and auxiliary reservoir in the brake release position. This diagram shows the engineer has placed the brake valve in the “Release” position. Pressure in the brake pipe is rising and enters the triple valve on the car, pushing the slide valve provided inside the triple valve to the left. The movement of the slide valve allows a “feed groove” above it to open between the brake pipe and the auxiliary reservoir, and another connection below it to open between the brake cylinder and an exhaust port. The feed groove allows brake pipe air pressure to enter the auxiliary reservoir to recharge the reservoir until its pressure is the same as that in the brake pipe. At the same time, the connection at the bottom of the slide valve will allow any air pressure in the brake cylinder to escape through the exhaust port to atmosphere. As the air escapes, the spring in the cylinder will push the piston back and cause the brake blocks to be removed from contact with the wheels. The train brakes are now released and the auxiliary reservoirs are being replenished ready for a brake application. Id.

FIG. 3B shows example brake application where the driver places the brake valve in the “Application” position. This causes air pressure in the brake pipe to escape. The loss of pressure is detected by the slide valve in the triple valve of each car. Because the pressure on one side (the brake pipe side) of the valve has fallen, the auxiliary reservoir pressure on the other side has pushed the valve (towards the right) so the feed groove over the valve is closed. The connection between the brake cylinder and the exhaust underneath the slide valve has also been closed. At the same time, a connection between the auxiliary reservoir and the brake cylinder has been opened. Auxiliary reservoir air now feeds through into the brake cylinder. The air pressure forces the piston to move against the spring pressure and causes the brake blocks to be applied to the wheels. Air will continue to pass from the auxiliary reservoir to the brake cylinder until the pressure in both is equal. This is the maximum pressure the brake cylinder will obtain and is equivalent to a full application. Id.

### Train Braking System Testing

Malfunction of a train's braking system can result in all sorts of problems including a catastrophic runaway train that can wreck the train. See e.g., “Runaway Train Hits 7 Homes; 3 Dead, 10 Hurt”, Los Angeles Times May 14, 1989. To prevent such accidents, Federal Railroad Administration (FRA) regulations require the air brake systems of trains, and the air brakes of individual cars, to be inspected and tested in certain circumstances. The regulations provide for five primary types of brake system inspections: Class I (initial terminal inspection), Class IA (1,000-mile inspection), Class II (intermediate inspection), Class III (trainline continuity inspection), and the SCT (single car test).

An in-depth summary, history, and analysis of the regulations affecting Class I, Class IA, Class II, and Class III brake tests, SCTs, and the operation and testing of end-of-train devices, are provided in the FRA final rule “Freight and other non-passenger trains and equipment; brake system safety standards; end-of-train devices,” 66 FR 4104. Jan. 17, 2001; and two subsequent modifications to that final rule that FRA promulgated in response to petitions for reconsideration, 66 FR 39683, Aug. 1, 2001, and 67 FR 17555, Apr. 10, 2002.

Briefly, a Class I air brake test, also referred to as an initial terminal inspection, is a comprehensive inspection of the brake equipment on each car in an assembled train that is required to be performed at the location where a train is originally assembled, when the consist is changed (e.g., other than by adding or removing a single car or solid block of cars, removing a defective car, or picking up multiple blocks of cars under the space or trackage constraints), and when a train is off-air for a defined number of hours. Class I brake tests help ensure that a train is in proper working condition and capable of traveling to its destination with minimal problems en route. A Class I brake test requires the performance of a leakage test and in-depth inspection of the brake equipment (on both sides of the freight car) to ensure that each car's brake system is properly secure, does not bind or foul, and responds by applying or releasing in accordance with a specified brake pipe pressure signal. Piston travel must also be inspected and adjusted to a specified length if found not to be within a certain range of movement.

A Class IA brake test-required every 1,000 miles-includes all the same elements of a Class I test, but with less stringent piston travel requirements. The most restrictive car or block of cars in a train determines the location where Class IA tests must be performed. For example, if a train travels 500 miles from its point of origination to a location where it picks up a block of cars that has travelled 800 miles since its last Class I brake test, and the crew does not perform a Class I brake test when adding the cars, then the entire train must receive a Class IA brake test within 200 miles, even though that location is only 700 miles from the train's origination.

Class II brake tests are less detailed inspections used for cars that do not have a compliant Class I inspection record that are picked up by a train at locations other than the initial terminal of the train, and where a Class I test cannot be performed. A railroad may utilize a Class II brake test where it is physically impossible to perform safely all of the requirements of the Class I brake tests; for example, where there is insufficient room to walk along both sides of the train. The Class II brake test includes a test for excessive brake pipe leakage, charging the air brakes to within 15 pounds per square inch (psi) of working pressure, making a 20-psi reduction in the brake pipe to actuate the brake, restoring pressure to working psi, releasing all brakes, and restoring full brake pipe pressure to the rear of the train. While a railroad may perform a Class II brake test, the rule requires a Class I brake test to be performed at the next available location in the car's line of travel in order to continue operating past that point. Due to the inefficiencies of this procedure, railroads generally perform the Class I brake tests in most instances where a Class II would be permitted as an alternative.

A Class III brake test must be performed any time the brake pipe is opened on an operating train. The test includes charging the air brakes to working pressure (no less than 60 psi at rear of train), making a 20-psi reduction in the brake pipe to actuate the brake on the rear car of the train, releasing the brake, and ensuring that pressure at the rear of the train is restored.

### Single Car Brake System Testing

In addition to the various types of train air brake tests noted above, the regulations require the brakes of individual cars to be maintained periodically and tested in certain circumstances. This test is known as an SCT (single car test) and is used to validate individual car air brake effectiveness. An SCT is required at least every 8 years for new or rebuilt freight cars, at least every 5 years for all other freight cars, and any time a freight car is on a shop track or repair track, if the car has not had an SCT in the previous 12 months.

Under 47 CFR § 232.305 (“Single car air brake tests”), single car air brake tests must be performed by a qualified person in accordance with either Section 3.0, “Tests-Standard Freight Brake Equipment,” and Section 4.0, “Special Tests,” AAR Standard S-486-18; Section 3.0, “Single-Car Test Requirements,” Section 4.0, “Special Tests,” and Section 13.0 “4-Pressure Single-Car Test Requirements,” AAR Standard S-4027-18; an alternative procedure approved by FRA pursuant to § 232.17; or a modified procedure approved in accordance with the provisions contained in § 232.307.

Except under certain circumstances, a railroad shall perform a single car air brake test on a car when: (1) A car has its brakes cut-out or inoperative when removed from a train or when placed on a shop or repair track; (2) A car is on a shop or repair track for any reason and has not received either: (i) A manual single car air brake test (AAR Standard S-486) within the previous 12-month period; (ii) An automated single car air brake test (AAR Standard S-4027 §§ 3.0 and 4.0) within the previous 24-month period; or (iii) Or a 4-pressure single car air brake test (AAR Standard S-4027 § 13.0) within the previous 48-month period; (3) A car is found with missing or incomplete single car air brake test information; (4) certain specified conventional air brake equipment items (Brake reservoir, Control valve mounting gasket, Pipe bracket stud, Service portion; Emergency portion; or) Pipe bracket) have been are removed, repaired, or replaced; or (5) A car is found with one or more of certain wheel defects such as Built-up tread, unless known to be caused by hand brake left applied, Slid flat wheel, unless known to be caused by hand brake left applied, or Thermal cracks.

The regulations further require each car to receive a single car air brake test no less than every 5 years and no less than 8 years from the date the car was built or rebuilt. Also, a single car air brake test must be performed on each new or rebuilt car prior to placing or using the car in revenue service.

See AAR Standard S-486, “Code of Air Brake System Tests for Freight Equipment—Single Car Test,” Revised 2018 (contained in AAR Manual of Standards and Recommended Practices, Brakes and Brake Equipment), also referred to as AAR Standard S-486-18; and (ii) AAR Standard S-4027, “Automated Single-Car Test Equipment, Conventional Brake Equipment—Design and Performance Requirements,” Revised 2018 (contained in AAR Manual of Standards and Recommended Practices, Brakes and Brake Equipment), also referred to as AAR Standard S-4027-18.

A single car test is really a series of sub-tests performed on a car's brake system to thoroughly examine all pneumatic and mechanical components of the brake system to ensure they are in an operational and safe condition before the car is returned to service. Such tests are based on testing procedures outlined in the Association of American Railroads (AAR) Standard S-486, “Code of Air Brake System Tests for Freight Equipment—Single Car Test.” SCABTs that directly follow the S-486 standard and rely on manual manipulation of levers and gauges read by humans are also referred to as manual SCABTs.

The single car testing involves connecting a pressurized air source to the car air brake system and performing:
a brake pipe leakage test,
Separate Brake Pipe Venting Devices testing (if present),
a system leakage test,
hand brake testing,
slack adjuster conditioning,
a service stability test,
an emergency test,
a release test after the emergency test,
a Minimum Application and Quick-Service Limiting Valve Test,
a Brake Cylinder Leakage Test,
a Slow-Release Test (with Variations for Car Length),
an Accelerated Application Valve (AAV) Test,
a Recheck of Piston Travel [without Block(s), if Car Is Equipped with
Automatic Slack Adjuster],
a Manual Release Valve Test, and
an Empty/Load Test.

See e.g., Code Of Air Brake System Tests For Freight Equipment—Single Car Test Standard S-486, AAR Manual of Standards and Recommended Practices Brakes and Brake Equipment Adopted: 1991; Last Revised: 2018.

### Automated Single Car Test Devices

While these steps may be performed manually, the regulations authorize the use of an automated single-car test device (“ASCTD”) to perform the tests automatically in rapid succession, to test whether the airbrake system on that particular car is working as intended. Automated devices, called automated single car test devices (ASCTDs), can perform equivalent steps as the manual SCABT procedure using computer programs that electronically record pressure. When this is done, the test performed is referred to as an automated SCABT. The equivalent steps are outlined by AAR Standard S-4027 “Automated Single-Car Test Equipment, Conventional Brake Equipment-Design and Performance Requirements.”

There are two types of automated SCABT available today: the automated end-of-car (EOC) test and the automated 4-pressure test, referred to as automated EOC and 4-pressure tests, respectively. The automated EOC test is closest in its procedure to the manual test, while the 4-pressure test adds improved testing capability to the SCABT by incorporating additional points of measurement and brake system access into the procedure. Either variety of automated tests adds improvements to a manual test by ensuring test procedures are consistently and accurately followed, documenting each test performed and its details, and improving speed that the test can be performed. The testing ensures that the components on the single car are not leaking and are functioning properly.

Automated Single Car Test Devices (ASCTD) offer significant time and cost savings over manual single car testing. They are approved and compliant to AAR specification S-4027 and scalable to accommodate future upgrades including ECP testing. The ASCTDs are claimed to improve the reliability of every car tested, and to save time and increase the accuracy of freight car air brake testing. Such ASCTDs are manufactured by various manufacturers such as Wabtec Corporation and Inter Swiss Ltd.

One industry standard such ASCTD manufactured by Wabtec Corporation is shown in FIGS. 4A-4D. The devices record and display system leakage and flow to the tenth of a psi in each respective pressure vessel. Documented test results provide an irrefutable record of compliance while reducing costly misdiagnosis and the erroneous removal of properly functioning valve portions. They are capable of running tests via the conventional end-of-car method or with a multi-Port receiver system which is claimed to provide better testing results in half the time. In the example SCTD shown, display options include a Windows-based user interface with 10″ touchscreen (see FIG. 4D) or an out-of-the box Wi-Fi capability for end users to connect wirelessly and interface with the device using their specific hardware/display. See www.wabteccorp.com/freight-car/braking-systems/automated-single-car-test-device (2022).

For more information concerning operations performed by conventional ASCTDs and the testing operations they perform, see for example “AAR S486 Compliant Single Car Air Brake Test Procedures Manual”, the Railway Educational Bureau, Simmons-Boardman Books (10th Ed. 2018); “Single Car Test Booklet—SCTWAB5 Freight Car Air Brake Test Specifications Using the Wabtec Automated Single Car Testers.”; and “Automated Single Car Test Device Gen III User's Guide”, Revision A (Wabco 2013).

### Single Car Test Reporting

Specialized accounting and data exchange systems track and bill for maintenance and repairs to each of these individual railway cars. See e.g., “Guide for Railroads” (2021 Railinc). Car Repair Billing (CRB) is Railinc's system for managing invoices of car repairs. The Car Repair Billing system has two different methods for submitting invoices: Car Repair Billing Data Exchange (CRBDX) and the Billing Repair Card (BRC) interface. The web-based Billing Repair Card (BRC) system is designed for small repair facilities and users who are not partnering with a car repair software vendor. With the BRC, users can enter and price railcar repairs, participate in Data Exchange and create paper invoicing. The BRC interfaces with Railinc's Car Repair Billing (CRB) system, ensuring accuracy and efficiency-up front. The Car Repair Billing Data Exchange (CRBDX) provides participating rail carriers and private repair shops the means to forward to Railinc a single file representing all billing information related to labor and materials used in connection with the repair of freight cars. Subscribing rail or private freight car owners receive one file representing car repair dollar amounts owed to rail carriers and private repair shops that performed repair services to their equipment. The data content presented via the CRBDX is published in the Car Repair Billing Procedures Manual (effective Nov. 16, 2022 Document Version Number 22.4).

Meanwhile, a different online system (e.g., the Umler® System maintained by Railinc) is used to report the car identifier, date and pertinent details of (and including alert cancellations associated with) each single car test performed. See “Field Manual of the AAR Interchange Rules. Rule 3. “Testing of Air Brakes” (AAR July 2018); “AAR Interchange Rules Revisions Update for 2021”, www.thecrma.org/files/2021aar.pdt; 2023 Field Manual of the AAR Interchange Rules. Specifically, one permutation of the Umler® system defines a particular data specification for reporting/storing single car air brake inspections that includes data fields such as due date (DU13), car grade (CG01), date the inspection was completed (DTDN), the Railroad Standard Carrier Alpha Code (SCAC) that reported the inspection (PERF), the Standard Point Location Code (“SPLC”) of the inspecting location (SPLC), and the type of air brake test device (e.g., Automatic non-4-Pressure, manual or Automatic 4-pressure) (B523). See Umler® Data Specification Manual (Effective Sep. 15, 2022) Reference Version 22.3.0. Different data may apply to different kinds of rolling stock such as passenger cars versus freight cars. The device shown in FIGS. 4A-4D may provide the data in the correct interchange format for uploading to the Umler® system.

A significant challenge to using such ASCTDs is properly reporting test results on a per car basis as federal regulations and data interchange standards require. In many cases, the technician using the ASCTD types the railcar's unique identifier into the device such as shown in FIGS. 4A-4D, connects the air hoses to the car, and then performs the test. Upon completion of the test, the technician typically inserts a thumb drive into the ASCTD system of FIGS. 4A-4D and manually pulls a copy of the report/record created for the railcar as a result of the test. The technician may then walk over to another computer, insert the thumb drive into that other computer, and save that record in a repository to prove to the FRA that the air brake test was performed on that particular car in a timely and proper manner. See left-hand (prior art) part of FIG. 10. This sounds like an easy process, but is in fact time consuming—it requires an extra step that sometimes never occurs. Instead, the test records often simply accumulate in the ASCTD device of FIGS. 4A-4D without ever being uploaded to a centralized database or repository as required. The memory within the device is limited, and older records will eventually be overwritten by newer records.

### BRIEF DESCRIPTION OF THE DRAWINGS

FIG. 1 shows an example prior art railcar air brake.

FIG. 2 shows an example schematic diagram of a prior art railcar air brake.

FIG. 2A shows an example schematic diagram of prior art railcar air brake components.

FIGS. 3A, 3B show schematic diagrams of a prior art air brake system in different operating modes.

FIGS. 4A, 4B, 4C, 4D show an example prior art ASCTD designed to automatically test a railcar's air brake system.

FIG. 5A shows a front view of an example jBox.

FIG. 5B shows a front perspective view of an example jBox.

FIG. 5C shows a rear perspective view of an example jBox.

FIG. 5D shows the rear perspective view of the example jBox with rear connectors open/revealed.

FIG. 6 shows an example jBox connected to interface with a prior art ASCTD.

FIGS. 7 & 7A show example internal views of a jBox.

FIG. 8 is a schematic block diagram of an example jBox.

FIG. 9 is a flow chart of example operations performed by a jBox.

FIG. 10 shows a flowchart of software controlled operations performed using a jBox.

FIG. 11 is a data structure diagram of results of a single car air brake test.

FIG. 12 shows a flowchart of example operations to access an online repository.

FIG. 13 shows a schematic block diagram of an overall example non-limiting system.

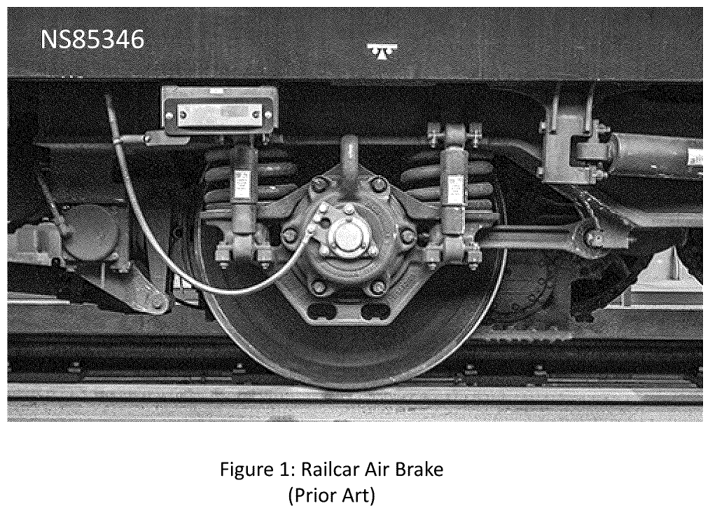

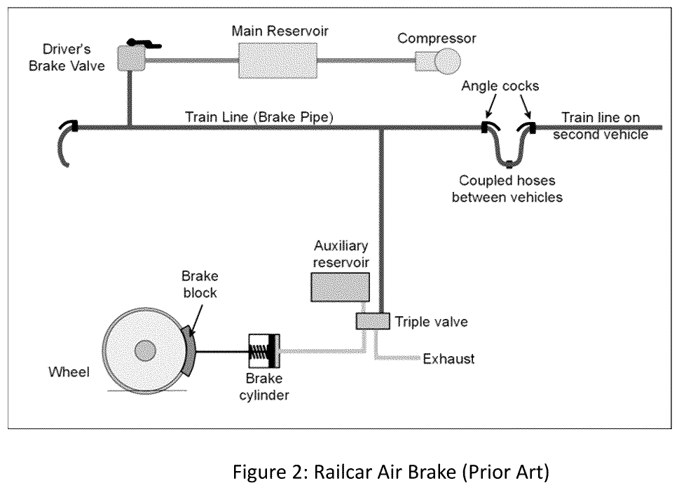

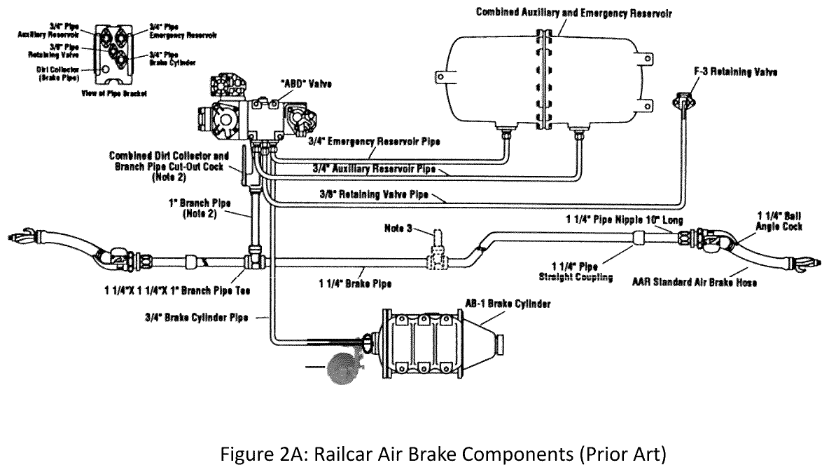

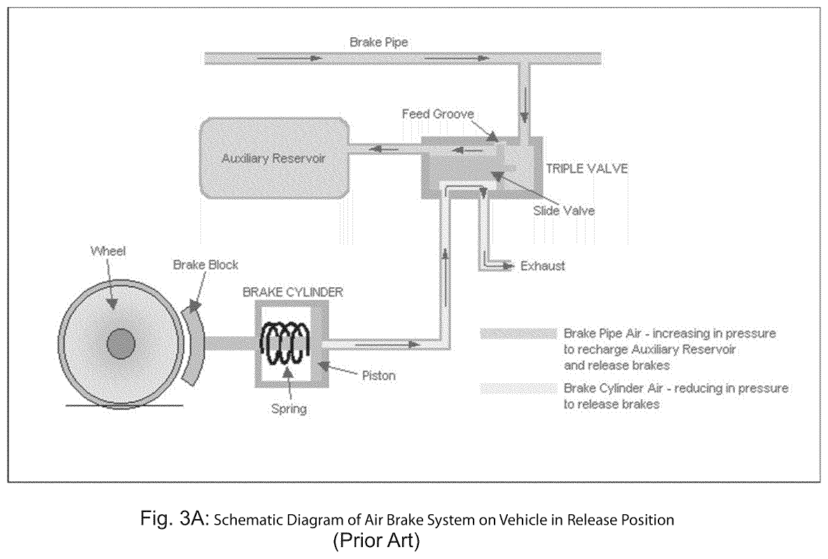

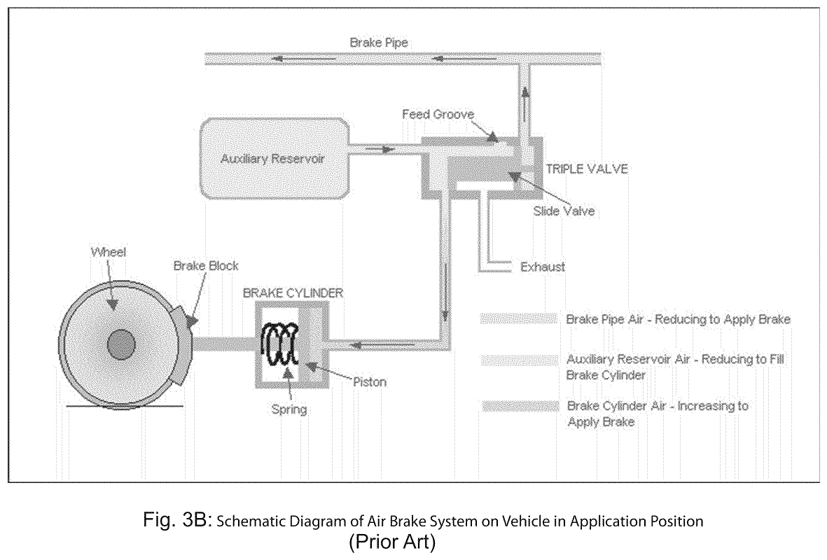

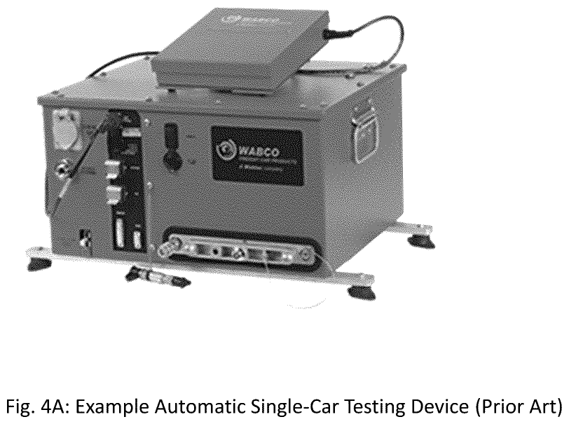

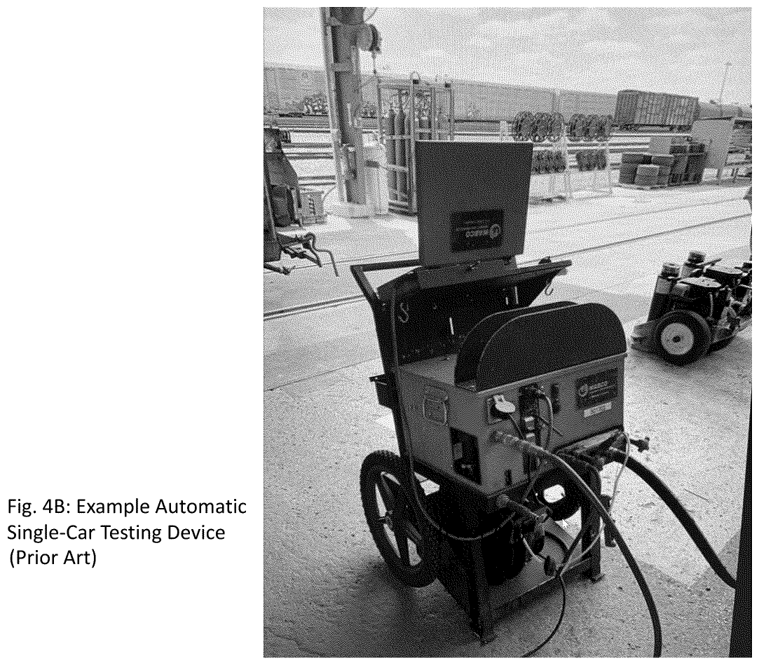

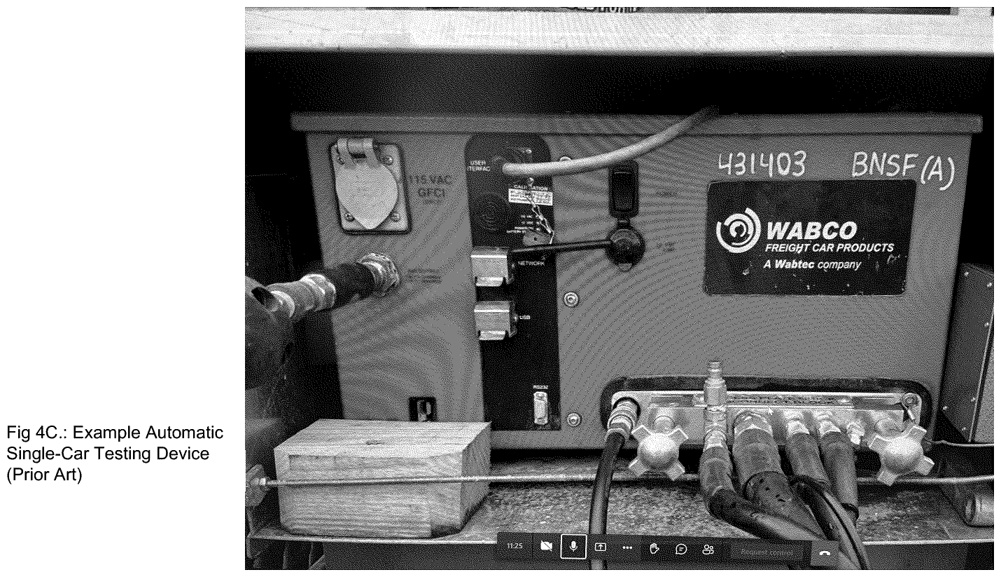

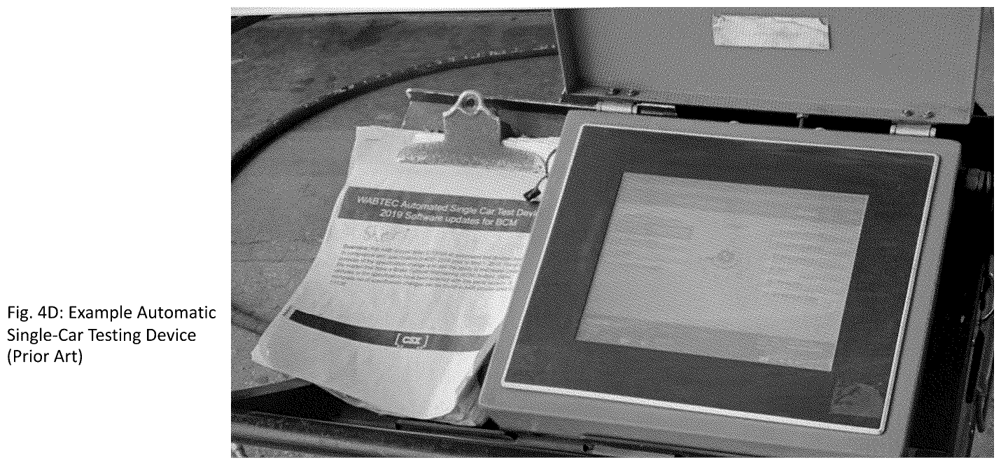

### DETAILED DESCRIPTION OF NON-LIMITING EMBODIMENTS

An example non-limiting embodiment provides an additional component, system or interface (“jBox”) that automates the transfer of the test result/report prepared by an ASCTD to a secure remote repository. In one embodiment, the jBox wirelessly connects to the remote repository and uploads digital records it obtains from the ASCTD over a network to the remote repository.

One embodiment of the jBox may communicate via a wire or wirelessly with the ASCTD using an internal or external port that permits the jBox to send read commands to the ASCTD using the ASCTD's API, and to receive the resulting report file data from the ASCTD. Thus, in one embodiment, the jBox may be external to the ASCTD and be separately powered by its own independent internal power supply. However, in another embodiment, the jBox may be a board, module or component or collection of components disposed within the housing of the ASCTD or even on a main or other printed circuit board within the ASCTD.

In one embodiment, a single button or other control on the jBox may be used to control the ASCTD to read the results of the tests from the ASCTD into the jBox, and wirelessly upload the automated test results to a remote secure repository. Thus, in one embodiment, the jBox interfaces directly to the Wabtec ASCTD, bringing brake testers online by combining an additional internal network interface with access to externally hosted servers and providing a path to the ASCTD. The jBox embodiment is specifically designed to capture results from the brake tester at a customizable interval and upload directly to a secured cloud-based database so the tester can feel confident that all records are stored and retrievable at any time without relying on human intervention. Furthermore, the jBox can supply—in response to a single button press—commands to the ASCTD to initiate the capture of the ASCTD database. This eliminates the need for the technician to navigate through complex menu sequences on the ASCTD touch screen interface. The technician need only key in the car's unique ID into the ASCTD's touch screen or preferred transitory device, connect the air hoses as appropriate, start the ASCTD test on the ASCTD's touch screen or preferred transitory device, and then depress the jBox's single button. The jBox does the rest by providing appropriate calls using the API of the ASCTD to supply the resulting test result/report to the jBox. The jBox then automatically uploads the test result/report to a repository in the cloud. This repository could be the operator's own repository, and/or the jBox cloud repository accessible by a user from any location at any time or by direct integration to a 3rd party Car Repair Billing application, and/or by Umler® System maintained by Railinc as described above. Uploading is performed independently from a network over cellular so little to no setup is required. Simply plug in the device and start uploading.

In one embodiment, the jBox uses the Wabtec ASCTD's existing interface port to communicate with the ASCTD. In one embodiment, the jBox replaces the touch screen tablet, keyboard accessory or other device the ASCTD normally uses (the ASCTD may connect via a wire or wirelessly with such an additional device such as a smart phone or wireless tablet to enable the technician to input the car's unique ID and run through the test procedure). The jBox can provide an additional or substitute connection with the ASCTD such as in one embodiment to allow the technician to control the ASCTD to run through test procedures and generate any corresponding error codes such as described in “Automated Single Car Test Device Gen III User's Guide”, Revision A (Wabco 2013), incorporated herein by reference. In other example embodiments, the jBox is not involved at all with controlling the testing ASCTD testing procedures, and instead is used primarily as an interface to read testing results (including time stamps, car identifier(s), any internal error codes, etc.) from the ASCTD's internal database and send such test results to one or more devices externally of the ASCTD as described in detail below.

Using the jBox is simple and will minimize the man hours required to print and save results. Once the mechanic completes the brake test, the mechanic can simply press the single Upload Button on the jBox and the jBox will take care of the rest. An included LED display will indicate the progress as the jBox immediately captures the results from the ASCTD and uploads to a secure database in the cloud. Once complete, the mechanic is free to delete the results from the ASCTD and continue to the next car. Pressing the button on the jBox will cause the jBox to retrieve any new records not previously retrieved from the ASCTD so no records are lost or omitted even if the technician forgets to press the button.

In one embodiment, the jBox may run a scheduled task that periodically reads the internal memory contents of the ASCTD. So even if the technician forgets to press the button, the jBox will still automatically retrieve any new records the ASCTD has stored internally since the last time the jBox checked the ASCTD's internal memory contents.

It is possible to access these results from anywhere by using a secured Web Portal to download reports captured from any location. Or, with a jBox Plus option, the jBox can be integrated with an existing CRB system using API to call results and attach directly to a billing record.

### Example Hardware Features:

4G/LTE capable
Weatherized/Rugged enclosure
2.4 GHz IEEE 802.11b/g/n wireless LAN, Bluetooth 4.2, BLE
Plug and Playable
GPS

### Cloud Features:

Access Results Anywhere
Securely stores results for future retrieval
Externally accessible ethernet connection
API for integration into existing software
Remote access to ASCTD

### Example Benefits:

Reduce man hours required to download and store results
Increase confidence in data retention with results stored securely in a
Cloud-based Database
Access results captured from locations from all over the Nation in one centralized Web Portal
Integratable into existing software for customized result retrieval
   Other non-limiting advantageous features include:
Automated capture of the Brake Tester database
Greatly reduces a car mechanic's work flow by limiting the amount of manual work currently required to store each individual brake test result generated by the Brake Tester
Ensures all results are securely captured each time a test is performed removing user error
Uploads captured database files to a Cloud database via Cellular or Wi-Fi
Provides access to test results at anytime from anywhere
Allows users to build reports/graphs on these results comparing all historical records in the database
Ensures long term data retention
Provides GPS location to accurately determine where each brake tester is being used on a yard
Provides remote control capabilities
Remotely control the Brake Tester to provide updates
Remotely control the Brake Tester to provide troubleshooting
Shows Online Status in a Management System to determine actual active usage of Brake Testers
Publishes Brake Tester information including ID tag to verify which testers are capturing information
This allows users to determine which brake tester may need servicing
Allows users to search through database reports based on Brake Tester ID
Acts as a Router to route traffic from the jBox to the Brake Tester

Allows users to connect their device via external ethernet or Wi-Fi to the jBox rather than directly to the brake tester. This improves user connectivity while performing tests as most Brake Testers are not equipped to handle multiple device connections at a given time.

The jBox includes both Wi-Fi and Cellular capabilities, providing 2 means of internet connectivity to store brake tester database files in a cloud-based server accessible remotely. This also provides GPS location for users to determine where Brake Testers are used in a yard, as well as provide full remote-control capabilities to the brake tester for remote upgrading, remote troubleshooting, and determining how many brake testers are powered on being used.

Example jBox Embodiments

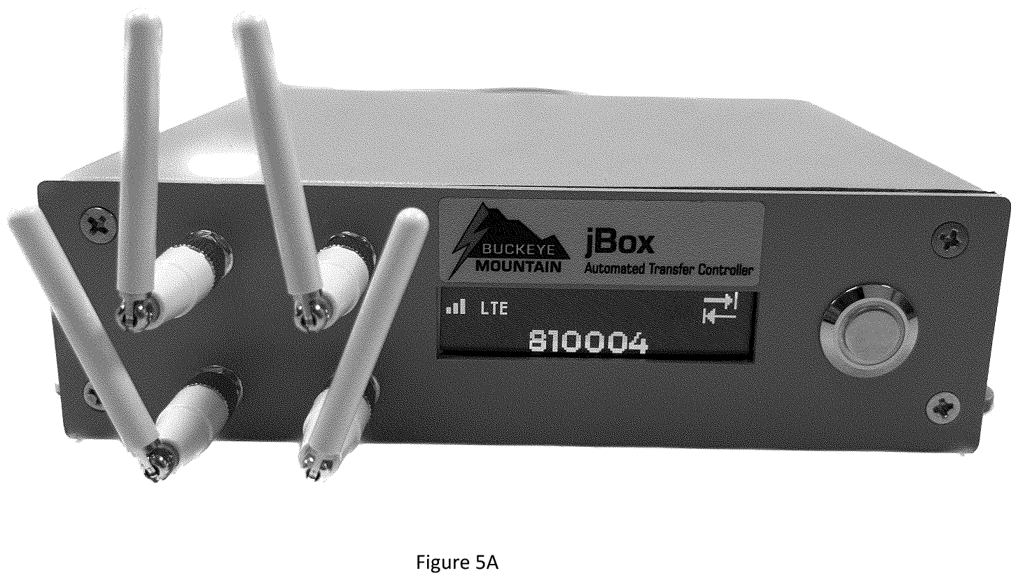

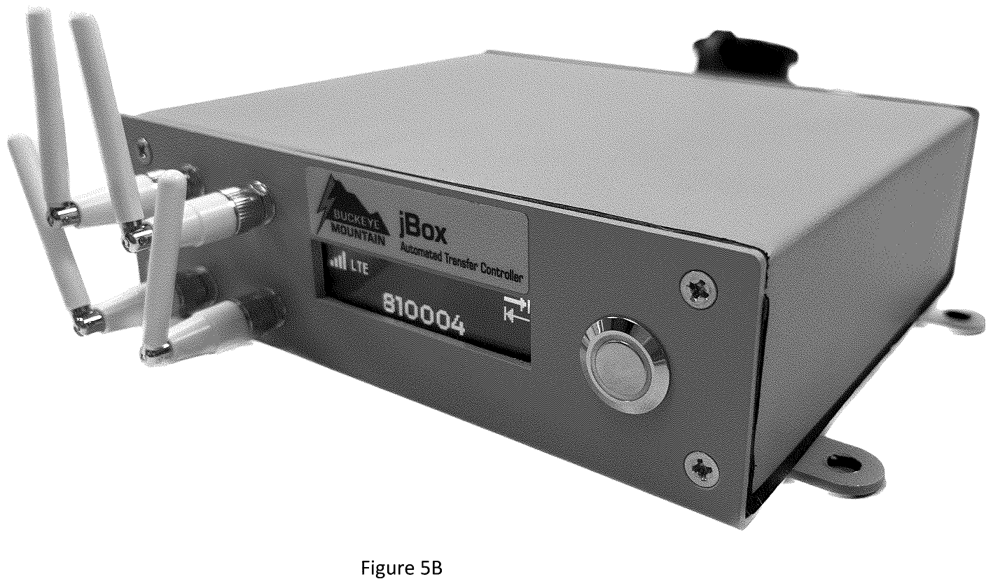

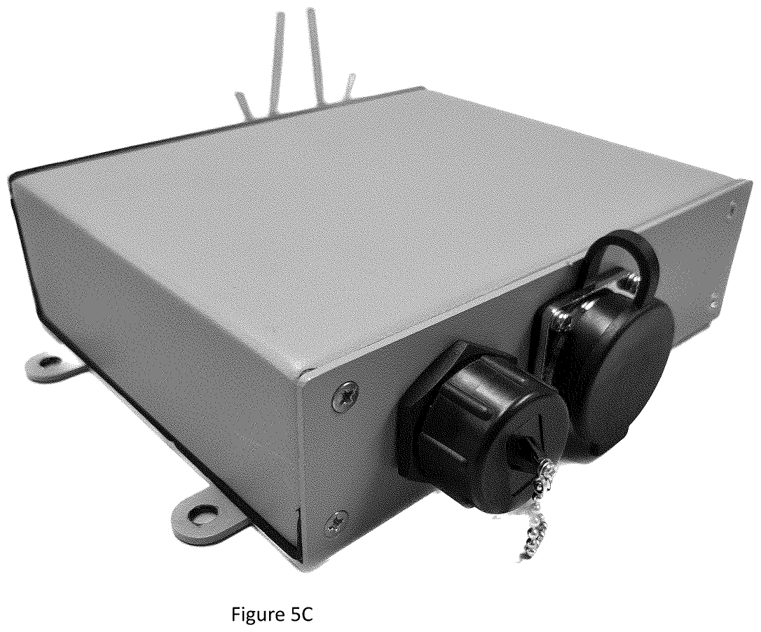

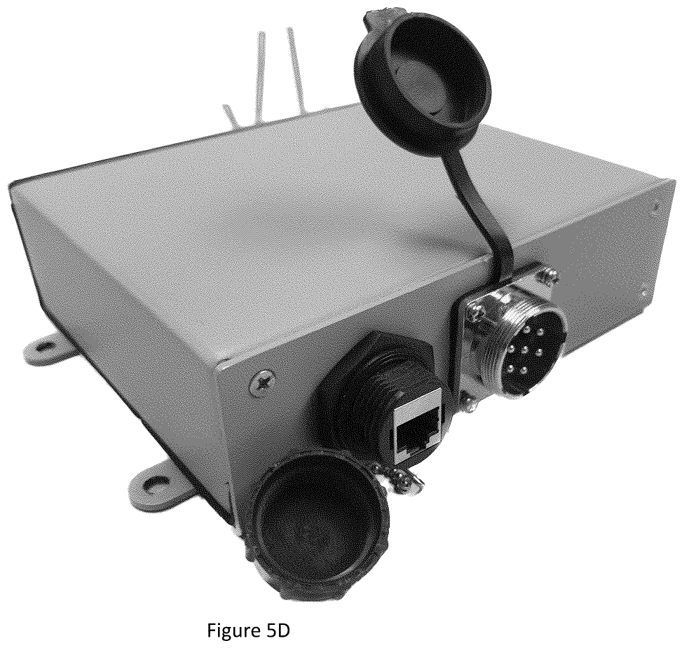

FIGS. 5A, 5B, 5C, 5D show example external views of an example jBox device. Note the housing with a cellular antenna array on the left-hand side of the front panel, an OLED display in the center, and a single push button on the right-hand side. The display shows the jBox is connected to a cellular telephone (data) network as well as a WiFi network. The number presented on the display indicates an identifier associated with the ASCTD the jBox is in communication with. The example rear panel shows two different kinds of connectors for use in connecting with external devices such as the ASCTD.

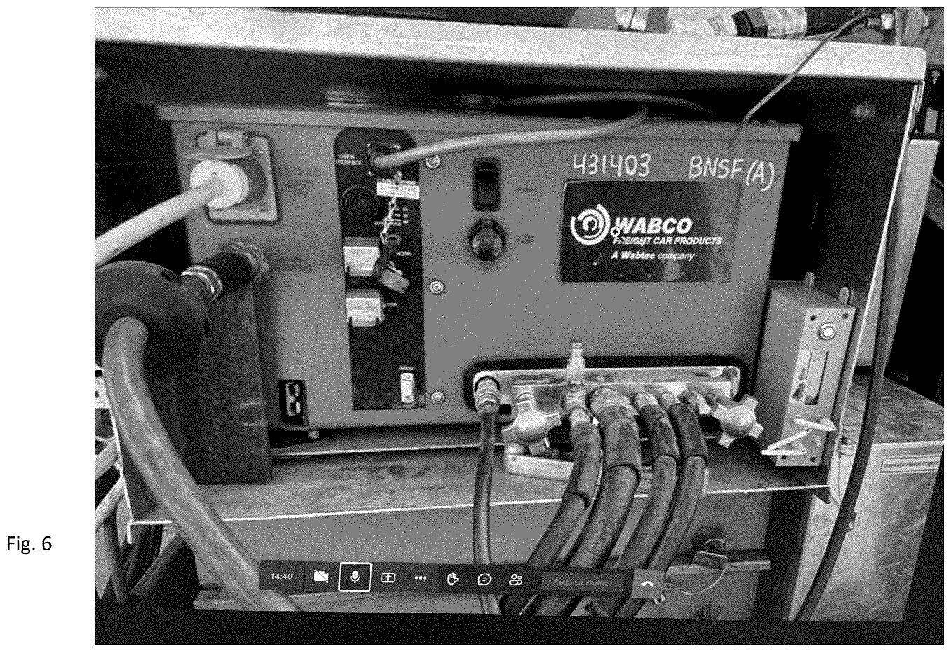

FIG. 6 shows the jBox connected to a prior art conventional ASCTD. In the example shown, the jBox derives power (12 VDC which it down converts to 5 VDC) from the ASCTD and is also connected to a multipin connector (e.g., ethernet) instead of or in addition to a tablet touch screen interface the ASCTD usually is connected to. The jBox can remain connected to and associated with the ASCTD permanently or semi-permanently.

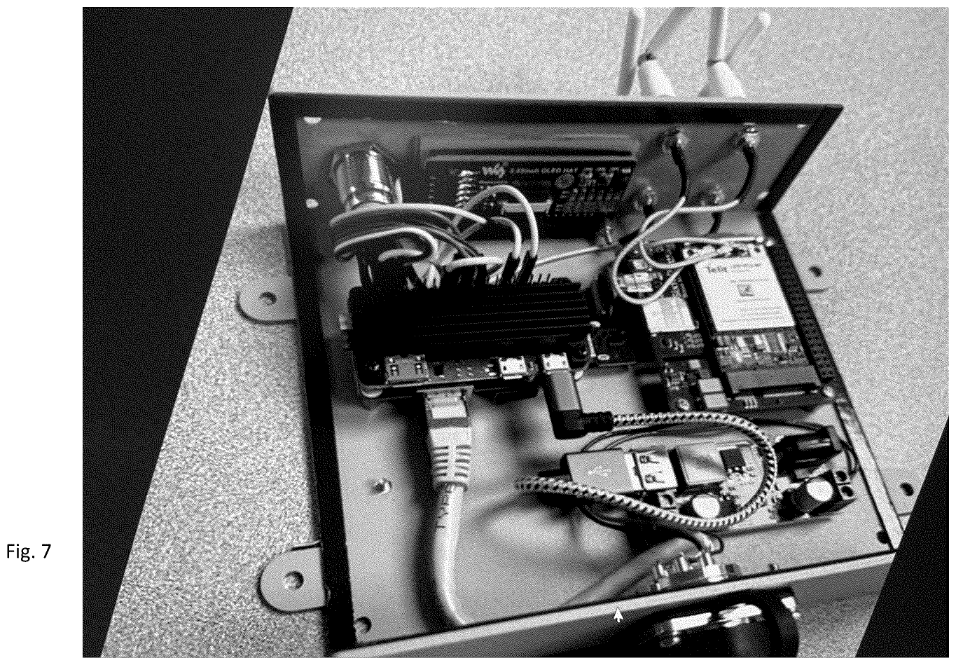

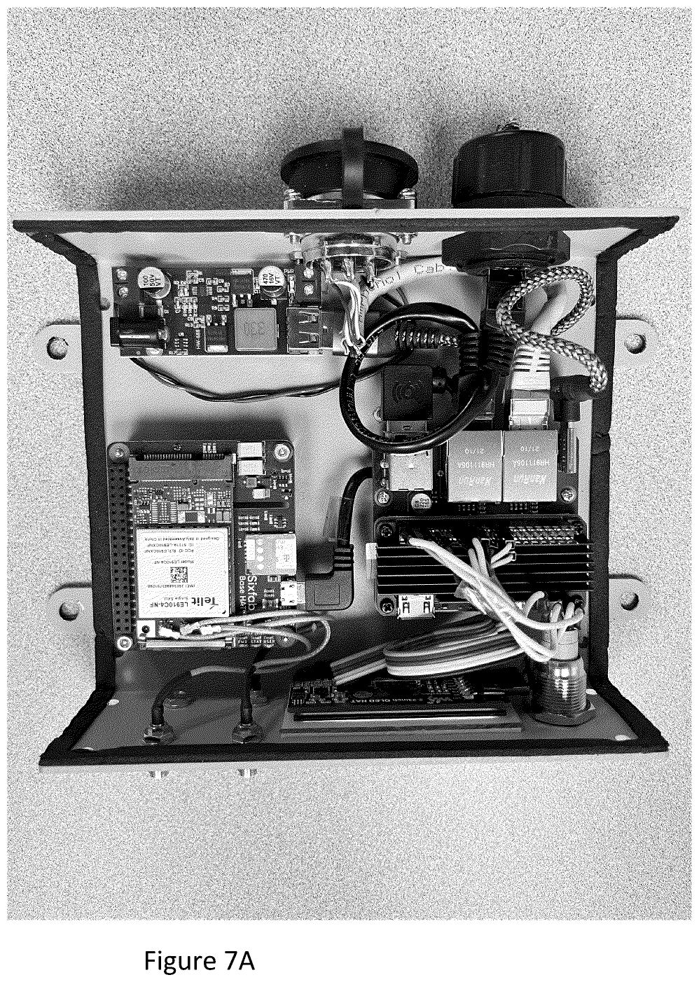

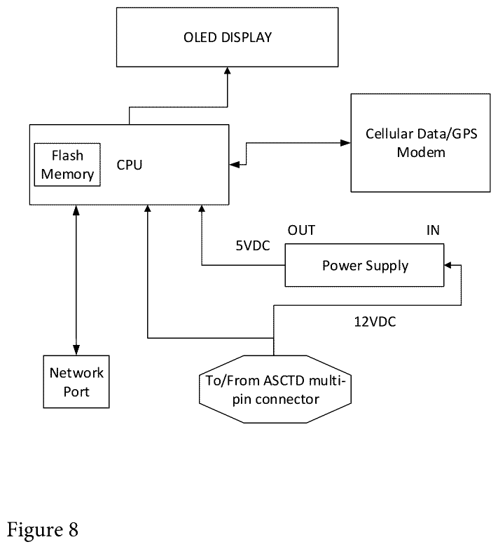

FIGS. 7 & 7A show an internal views of the jBox and FIG. 8 is a corresponding schematic block diagram. The jBox in this example includes a CPU that executes software instructions stored in non-transitory memory such as flash memory, to perform operations described below. The jBox communicates with the ASCTD via an ethernet connection or other port and also via a custom multipin cable connector as shown, from which the jBox can also derive power from the ASCTD. The jBox includes a wireless communications interface with cellular telephone (data) and WiFi capabilities and which also includes a GPS (Global Positioning System) receiver providing geocoordinates such as grid coordinates.

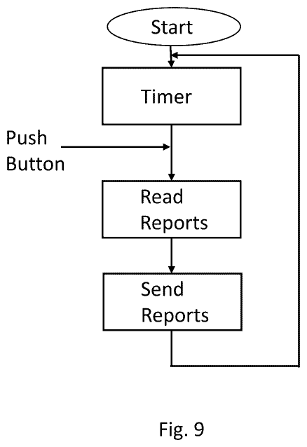

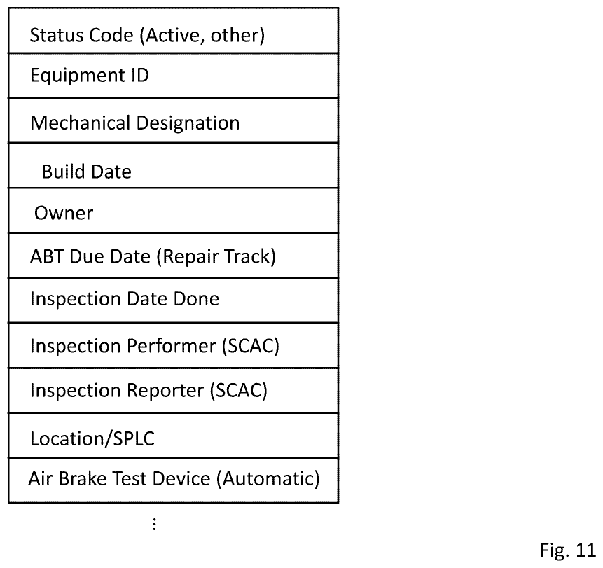

FIG. 9 shows basic operations the jBox CPU performs under software control. The jBox will generate commands using the API command protocol of the ASCTD to read and receive test reports from the ASCTD either in response to a button push or on a periodic basis, and transmit the reports to a secure repository in the cloud. These reports may include information such as shown in FIG. 11 including the equipment ID of a railcar, the date the air brake inspection was performed, who performed the inspection, who reported the inspection, the location of the inspection and type of air brake test device (in this case, automatic and probably 4-pressure automatic) and any error codes or other test results generated by the ASCTD. In one embodiment, some of the FIG. 11 fields are prefilled or write only. In one embodiment, the jBox does not report any air brake inspection that failed—in other words, all reported inspections are passed inspections. Other embodiments could operate differently, however.

In more detail, in one embodiment the jBox utilizes the “User Interface” that exists on the front of the Wabtec ASCTD to obtain both Power and Ethernet data communications. The jBox pulls information from the ASCTD's internal server and redisplays this information on the LCD screen and also stores this information in an internal file for query by an online management system. The jBox includes a single push button that allows the user to capture and upload the ASCTD database file with a single push button. Through the network connection provided by the User Interface port, the database file is downloaded from the ASCTD to the jBox and is uploaded by the jBox to an external device(s) using either the Wi-Fi or Cellular network adapters built into the jBox. Both Cellular and Wi-Fi signal strength are presented on the LCD screen. Status of the capture and upload process is also displayed on the same screen through a loading bar. The jBox will also automatically pull the Database file for upload independently of the push button to maintain the latest database results regardless of user input.

An Ethernet Port exists on the back of the jBox (see FIG. 5C, 5D) that is connected to an additional network interface in the jBox. This port is designed to allow users to interface with the Brake Tester through the jBox rather than connecting to the Brake Tester itself which could result in network performance degradation. The jBox also broadcasts a Wi-Fi SSID that can be connected to by a user for wireless interfacing to the Brake Tester.

When the jBox uploads Brake Tester Database to the Cloud Database, the Cloud Database consumes the database file and removes any duplicate entries. All results are then stored on the Cloud Database for review through a specialized Web Portal or by integrating a billing system that can query the required Brake Test Result and apply it to a billing record.

An online management system is used for remote controlling the jBox. The jBox connects to the online management system either through Cellular or Wi-Fi at the preference of the user. The management system also reads GPS data retrieved from the jBox and publishes information about the connected brake tester to an online console. Reports can be generated from the management system to determine but not limited to operation time, device location history, and usage.

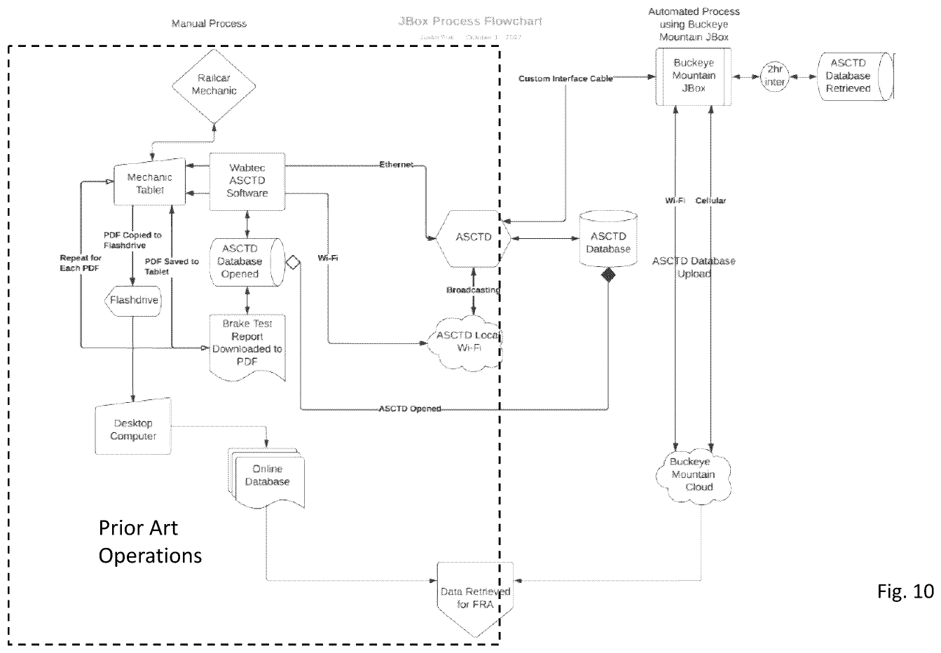

FIG. 10 shows on the right-hand side a high level operation of the jBox in reading the reports from the ASCTD via a custom interface cable at predetermined or other time intervals such 2 hour intervals and storing the reports in an internal database for wireless reporting to a repository in the cloud.

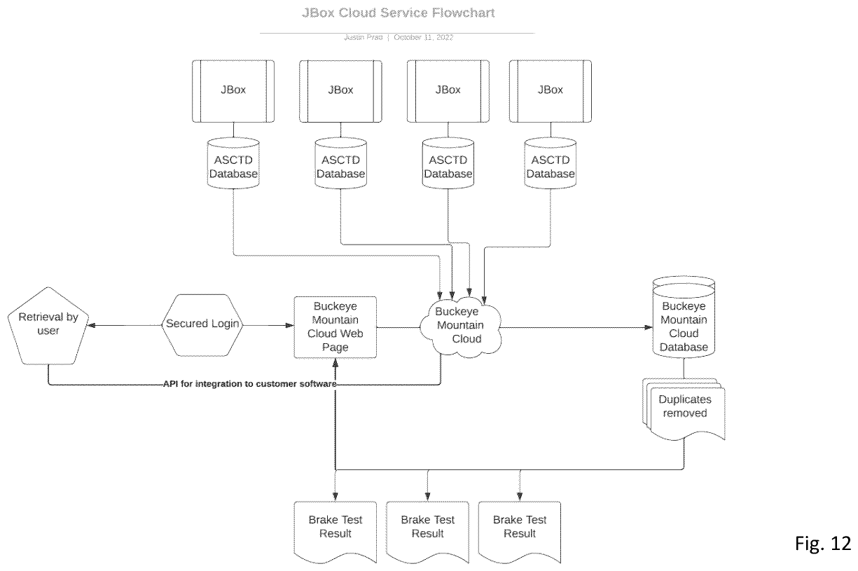

FIG. 12 shows multiple jBoxes with associated internal databases that each send their contents to a cloud database. Duplicate reports are removed. A web based interface hosted by a web server including a CPU and non-transitory storage allows users via secured login to retrieve brake test results. The user may then upload these brake test results to the Umler® system or the web server may automatically upload the brake test results to the Umler® system or the Umler® system could incorporate an interface to the jBoxes.

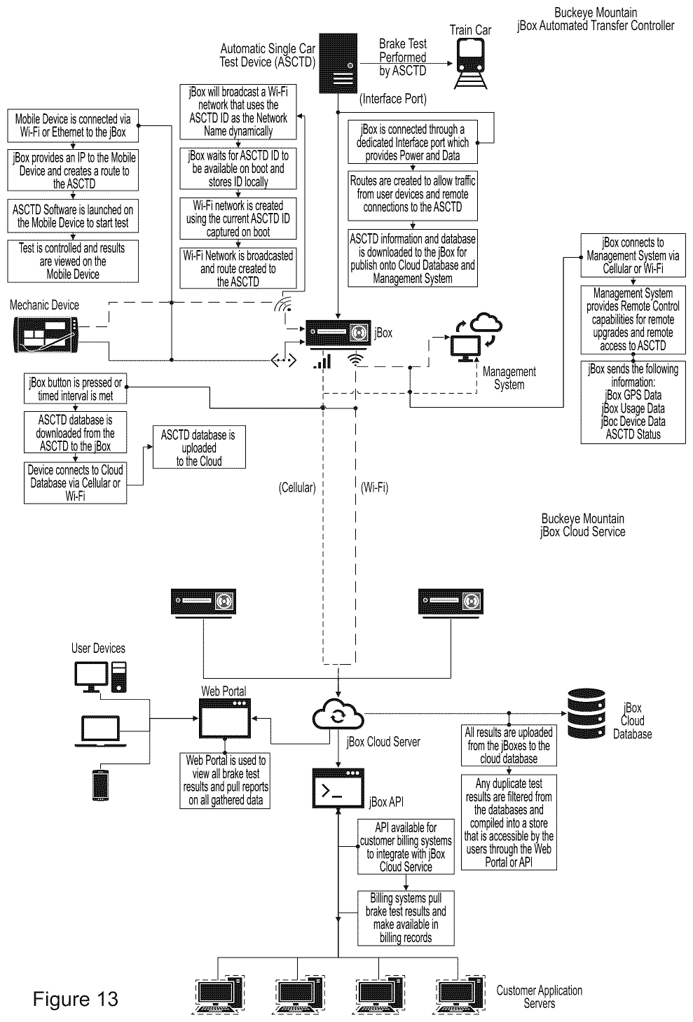

FIG. 13 is a schematic block diagram of an example overall non-limiting system. In the example shown, a brake test of a train car is performed by an ASCTD. jBox is connected to the ASCTD through a dedicated interface port which provides power and data. Routes are created to allow traffic from user devices and remote connections to the ASCTD interface port. ASCTD information and database is downloaded from the ASCTD via the interface port to the jBox for publishing onto a cloud database and management system.

In the example shown, the jBox provides both cellular and WiFi wireless connectivity to various external devices including a mechanic device, a management system, and a cloud server. The wirelessly-connected mechanics device may be any kind of smart device including a processor, a memory and a user interface, such as a tablet or a smart phone. The mechanics device (which may be a mobile device) connects to the jBox via Wi-Fi or Ethernet and receives an IP address. The jBox then creates a route to the ASCTD. ASCTD software (e.g., one or more applications or “apps”) are then launched on the mechanics device to allow the mechanic to control the operation of the ASCTD via the mechanics device. In such examples, the tests are controlled and the results are viewed on the mechanics device, with the jBox generating ASCTD commands and providing such commands to the ASCTD via the ASCTD interface port. Thus, in one embodiment, the mechanics device and the jBox provide a substitute or additional user interface for the ASCTD that the mechanic can use instead of or in addition to any user interface the ASCTD may already provide.

In the example shown, the jBox has a button on its front panel as indicated above. When the jBox button is pressed (or a predetermined time interval has elapsed and/or a control command is provided via the mechanic device), the jBox sends commands to the ASCTD via the ASCTD's interface port that controls the ASCTD to download its internally-stored database of test results to the jBox. The jBox then connects to a cloud database via a cellular or Wi-Fi connection, and uploads the ASCTD test results database to the jBox cloud database in the cloud.

In one example, the ASCTD makes this same file the jBox obtains available for users to download manually. However, in one example embodiment, the jBox remains connected and grabs this file with or without manual intervention. Here is the process the jBox follows:
Connect to ASCTD
Set Route to ASCTD Network on reserved network interface
Check ASCTD Connection
Verify connection by checking ID
Download ASCTD Database file and store locally
Check connection to Cloud Database
Make secure connection to Cloud Database
Check if Database File exists
Upload Database File(s) to Cloud Database
Optional—sends an email to specified address informing of upload status ie Success+database file name(s) or failure and reason

If the above process fails at any point, the user is notified via the OLED display.

One embodiment of jBox provides an additional feature to the Wi-Fi Broadcast function of the jBox to solve another fundamental issue with the ASCTD as a standalone device. The ASCTD broadcasts its own Wi-Fi network for users to connect their tablet to and perform tests with. This Wi-Fi network may be unstable however, so jBox broadcasts over its own Wi-Fi network which it supports as an Access Point (“AP”).

However, in some implementations, the ASCTD Wi-Fi network is named the same across all ASCTD devices—in other words, each ASCTD has a default SSID for its WiFi network that is the same as every other ASCTD. This creates a problem for the user as they do not know which ASCTD they are connecting to when they need to interface with it—especially if there are several ASCTDs in a small area. To resolve this, an example jBox embodiment implements a process to capture the ID of the ASCTD machine and create a Wi-Fi network that uses this ID as the WiFi network name dynamically. Here is how this process is made to work:

On boot, the jBox will check connection to the ASCTD continuously until the ASCTD is fully powered on

The jBox will capture the ASCTD ID and store this information locally in a temp file

The jBox creates the configuration file for Wi-Fi and uses the ASCTD ID captured from the previous step as the SSID

The jBox enables the Wi-Fi Broadcast service and sets routes to the ASCTD through this interface

The jBox will not present any Wi-Fi network until the current ASCTD ID is captured. This way the jBox will always broadcast the correct ID of the ASCTD that it is currently connected to.

This feature allows a user to connect their tablet or other user interface device to a particular ASCTD through the jBox WiFi network named with an SSID (service set identifier or “network name”) that comprises or includes or is associated with or otherwise indicates the ASCTD's unique identifier. In a crowded rail yard or shop area having multiple ASCTDs, the user can in this way connect their device to a desired particular ASCTD they want to connect to, e.g., by selecting, from a list of available WiFi connections, the WiFi interface automatically displays. Once the user device connects wirelessly to the jBox, the jBox acts as a router or access point to route packets from the user device to the ASCTD and from the ASCTD to the user device.

In one embodiment, the jBox is also capable of connecting wirelessly to a management system via cellular or Wi-Fi. The jBox provides a route to the ASCTD from the management system enabling internet access to all ASCTDs paired with a jBox. The jBox is then capable of providing information of the jBox itself and the connected ASCTD directly to the management system over the internet. For example, the jBox may send the following information to the management system:
jBox GPS data (i.e., one or more geocoordinate the jBox automatically detects from geosynchronous satellites indicating the jBox's location on the earth's surface)
jBox usage data
jBox device statistics
ASCTD status information
Remote access to the ASCTD's locally hosted web interface other.

For example, the jBox may also receive the following information from the management system:
jBox Software Updates
ASCTD Software Updates

The bottom part of FIG. 13 shows a jBox cloud server architecture that can connect to any or all of a plurality of jBoxes via Wi-Fi, cellular connections and/or the Internet or other network. The jBox cloud server in the example shown interconnects with the cloud database referred to above as well as to a web portion and to a jBox API. As described above, all results are uploaded from the jBoxes to the cloud database (in one embodiment, any duplicate test results are filtered out and not stored in the database), and the results are compiled into a store that is accessible by the users through the web portal API.

The web portal in the example shown allows any of a plurality of user devices of various types to view brake test results and pull reports on all gathered data.

The jBox API provides a command pipe that allows customer application servers to integrate customer billing, test or other systems with the jBox cloud service, thereby enabling billing systems to pull brake test results and make them available in billing records.

All patents and publications cited herein are incorporated by reference.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A wireless interface comprising:
a first interface configured to maintain a connection with an automated single car test device;
a second interface configured to provide internet connectivity; and
a third interface configured to provide local communication with the automated single car test device,
wherein at least one of the interfaces captures automatic brake test results comprising at least a unique railway car identifier, a geocoordinate, a single car air brake inspection date, and an indicator that an air brake test was performed using the automated single car test device.

2. The wireless interface of claim 1 wherein the first interface is further configured to capture air brake test results periodically from the automated single car test device.

3. The wireless interface of claim 1 wherein the first interface is further configured to read air brake test results from the automated single car test device in response to a manual operation such as a button push.

4. The wireless interface of claim 1 wherein the second interface wirelessly sends the captured air brake test results to a web server that wirelessly communicates with a plurality of wireless interfaces connected to different automated signal car test devices.

5. The wireless interface of claim 1 wherein the second interface wirelessly provides external internet access to and from the automated single car test device.

6. The wireless interface of claim 1 wherein the third interface wirelessly provides a dynamically unique wireless local area network with route to the first interface.

7. The wireless interface of claim 1 wherein the automated single car test device has a housing, and the wireless interface is configured to be external to the automated single car test device housing.

8. The wireless interface of claim 1 further including a power converter that converts power supplied by the automated single car test device for powering the first, second, and third interfaces.

9. The wireless interface of claim 1 wherein the first interface is configured to connect to the automated single car test device via a touchscreen tablet multipin connector, thereby providing network connectivity to and from the first interface to the second and third interfaces.

10. The wireless interface of claim 1 wherein the first interface is used to capture details of the automated single car test device and to configure the second interface for a uniquely identified wireless local area network.

11. A wireless interface comprising:
a first interface configured to maintain a connection with an automated single car test device; and
a second interface configured to provide local wireless communication between at least one wireless device and the automated single car test device,
wherein the first interface reads an identifier from the automated single car test device and the second interface configures the local wireless communication to indicate information associated with the identifier.

12. The wireless interface of claim 11 wherein the second interface configures an SSID to include the automated single car test device identifier.
